(19) United States
(12) Patent Application Publication
(10) Pub. No.: US 2006/0174003 A1
(43) Pub. Date: Aug. 3, 2006

(54) Access control using file allocation table (FAT) file systems

(76) Inventors: Christopher S. Wilson, Sunnyvale, CA (US); Viresh Rustagi, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/339,154

(22) Filed: Jan. 25, 2006

Related U.S. Application Data
(60) Provisional application No. 60/648,476, filed on Jan. 31, 2005.

(51) Int. Cl. G06F 15/16; G06F 15/173

(52) U.S. Cl. 709/225; 709/217

(57) ABSTRACT

Herein described is a system and method of providing access to data stored in non-data pool or legacy file systems, such as those file systems that utilize file allocation tables (FAT). The method associates one or more FAT partitions of a FAT file system to one or more shares or share directories. A share or share directory is identified using one or more variables provided by a data storage device. The method comprises providing a level of access based on a username and/or password used to authenticate a user. The system comprises a memory, software resident in the memory, and a processor that executes the software. When executed, the software may generate a share that identifies the corresponding FAT partition. The user may be granted access to the share when the username and/or password is authenticated. Further, the appropriate level of access may be determined by the username and/or password.

### CROSS-REFERENCE TO RELATED APPLICATIONS/INCORPORATION BY REFERENCE

This application makes reference to and claims priority from U.S. Provisional Patent Application Ser. No. 60/648,476, entitled “ACCESS CONTROL USING FILE ALLOCATION TABLE (FAT) FILE SYSTEMS” filed on Jan. 31, 2005, the complete subject matter of which is incorporated herein by reference in its entirety.

This application makes reference to:

U.S. application Ser. No. 11/087,136 (Attorney Docket No. 15675US03), filed Mar. 22, 2005; and

U.S. application Ser. No. ______ (Attorney Docket No. 16420US02), entitled “METHOD AND SYSTEM FOR FLEXIBLY PROVIDING SHARED ACCESS TO NON-DATA POOL FILE SYSTEMS”, filed Jan. 25, 2006.

The above stated applications are hereby incorporated herein by reference in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In certain instances, it may be necessary to access data stored in legacy file systems. The data may be stored using file allocation tables (FAT) in such legacy file systems. One or more users may wish to access the data that is stored in a FAT (file allocation table) file system. An administrator may wish to provide shared access to data stored using the FAT file system. For example, the one of more users may wish to access the data stored using the FAT file system by way of using shares or shared directories provided by one or more data pools of a data storage device. Unfortunately, providing such shared access may be difficult, if not impossible to accomplish.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a system and a method of providing access to data that is stored using file allocation tables (FAT), substantially as shown in and/or described in connection with at least one of the following figures, set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 illustrates a block diagram of a typical system incorporating the use of a data storage device (or network attached storage device (NAS)) that is used to provide access to one or more file systems, in accordance with an embodiment of the invention.

FIG. 2 is a block diagram of a data storage device or NAS used to implement shared access to one or more FAT partitions of a FAT file system of a computing device, in accordance with an embodiment of the invention.

FIG. 3 illustrates a block diagram of a typical FAT file access control system incorporating the use of a data storage device or NAS that is used to provide access to a FAT file system, in accordance with an embodiment of the invention.

FIG. 4 is an operational flow diagram illustrating a method for accessing a FAT partition of a FAT file system in a computing device, in accordance with an embodiment of the invention.

### DETAILED DESCRIPTION OF THE INVENTION

Various aspects of the invention provide a system and method of providing access to data stored in non-data pool or legacy file systems, such as those file systems that utilize file allocation tables (FAT), such as FAT32. File allocation tables comprise a file system used in a typical MS-DOS or Windows 95 file system. Access to data may be enabled or disabled by configuring one or more variables used in a data storage device. In a representative embodiment, the data may be stored in one or more FAT partitions created using one or more data storage drives. The data storage drives may comprise hard disk drives, for example. The variables may be represented using values that are stored in the data storage device. The values may be stored by using a memory of the data storage device. The memory may comprise a non-volatile random access memory (NVRAM). The data storage device may comprise one or more data storage drives or hard disk drives. The data storage device may implement one or more data pools. The one or more data pools may comprise one or more shares or shared directories of a Reiser file system, for example. One or more authorized users or members of a share may access data stored in the share or the data storage device. In a representative embodiment, the data storage device may be alternatively referred to as a network attached storage device (NAS). Details on the function and operation of a NAS may be found in U.S. application Ser. No. 11/087,136, filed Mar. 22, 2005. By way of using the data storage device (or NAS), the various aspects of the present invention allow access to data stored using a FAT file system. The data may be stored and accessed from a data storage drive or hard disk drive resident within one or more computing devices that are communicatively coupled to the data storage device. The hard disk drive that is used in a computing device of such legacy file systems (those systems that utilize FAT32 and NTFS) may be referred to as a legacy drive. The legacy drive may comprise one or more FAT partitions used to store data. The one or more FAT partitions may comprise sectors and/or clusters. The one or more computing devices may comprise a computer or PDA for example, which utilizes a FAT file system in an MS-DOS operating system. The NAS may comprise a memory and/or flash memory. The memory and/or flash memory may be used to store the previously mentioned one or more values. The one or more variables are configured using a set of one or more values. The set of one or more values may be used to uniquely identify a FAT partition by way of using a share. The share may be mapped to the FAT partition. The NAS comprises software and/or firmware that may be stored in the memory or flash memory. In accordance with various aspects of the present invention, execution of the NAS software provides a mechanism for identifying one or more FAT partitions of a FAT file system, by way of implementing one or more shares using the data storage device (or NAS). In addition, a transmission mechanism may employ the use of a protocol such as a Common Internet File System (CIFS) protocol for transmitting data stored in FAT file systems to a user of the NAS. It is contemplated that other protocols such as NFS, HTTP, FTP, and the like may be used as the transmission mechanism. As a result of this transmission mechanism, the one or more FAT partitions may be identified using one or more shares.

In a representative embodiment, each FAT partition on a legacy drive is identified as a separate share. A share in a legacy drive may be identified using one or more non-volatile random access memory (NVRAM) variables. Their associated values are stored in a non-volatile memory such as a non-volatile random access memory (NVRAM). In a representative embodiment, the NVRAM is located within the NAS. The NVRAM variables may specify what may be referred to as a share-specific variable set. The share-specific variable set may be used to uniquely identify a non-data pool share. The non-data pool share may comprise one or more FAT partitions, for example. The non-data pool share may be alternatively referred to as a “foreign share” since it is specified differently compared to a data pool share. A data pool share is a share that is normally generated by a NAS when its NAS software is executed. Such data pool shares may be referred to as “native shares” since they utilize data storage drives (or hard disk drives) located within the NAS. Details regarding the share-specific variable sets and NVRAM variables, as applied to the implementation of foreign shares when accessing data originating from legacy drives using legacy file systems, may be found in U.S. application Ser. No. ______ (Attorney Docket No. 16420US02) filed Jan. 25, 2006.

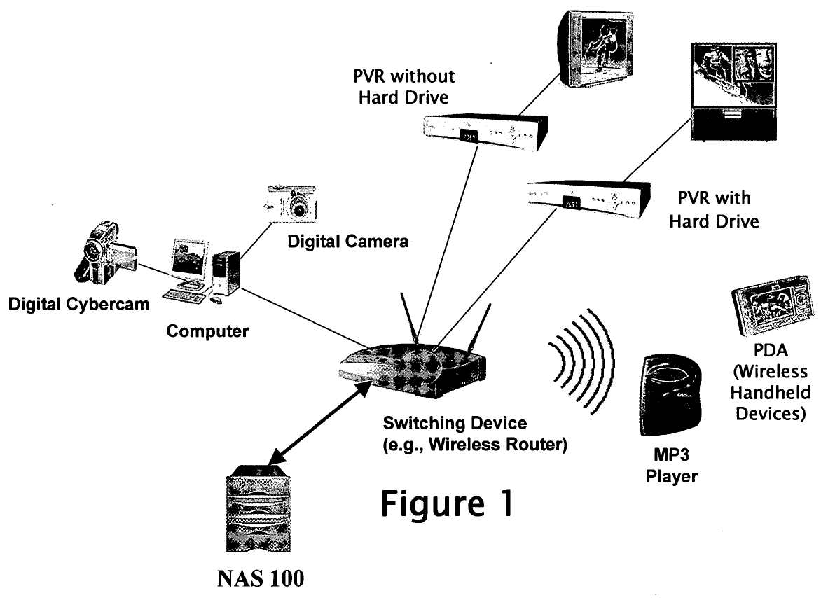

FIG. 1 illustrates a block diagram of a typical system incorporating the use of a data storage device or network attached storage device (NAS) 100 that is used to provide access to one or more file systems, in accordance with an embodiment of the invention. In a representative embodiment, the file system comprises a FAT file system. The NAS 100 provides data storage for one or more data processing or computing devices. As illustrated, an exemplary switching device provides connectivity of the NAS 100 to the one or more data processing devices. The switching device may be capable of providing connectivity using wireless or wireline communications. For example, a wireless router may utilize any one of the following wireless or wireline data communications protocols: 10/100 Ethernet, gigabit Ethernet, 802.11x, Bluetooth, and the like. The one or more data processing or computing devices may comprise a personal computer (PC), digital cybercam, digital camera, MP3 player, PDA, and one or more personal video recorders (PVRs). The NAS may generate one or more shares for each of the one or more data processing devices may employ the use of a FAT file system. As illustrated, the PVR may be equipped with or without a hard disk drive. In a representative embodiment, the PVR may be referred to as a set-top-box (STB) that incorporates personal video recorder capabilities. As a consequence, the PVR may be referred to as a PVR-STB. As shown, the PVRs are connected to a television or a monitor capable of displaying multimedia content to a user. Use of the NAS 100 provides a centralized storage device for multimedia content received by the one or more PVRs. As a consequence of storing content into a NAS 100, PVRs lacking a storage facility, such as a hard disk drive, may store any data it receives into the NAS 100. Further, any data stored by other data processing devices, including PVRs, may be easily accessed and viewed by any of the one or more data processing devices. For example, a PVR without hard drive may access multimedia content originally stored into the NAS 100 by a PVR with hard drive, and vice-versa. As a result, the NAS 100 facilitates sharing of data among the one or more data processing devices. Since it provides a remote storage mechanism, the NAS 100 may be considered a “virtual storage device” by the one or more data processing devices. The NAS 100 is configured such that its storage capacity may be easily expanded. For example, the NAS 100 may accept one or more additional hard disk drives. A NAS 100 may be configured to easily accept additional data storage drives, such as hard disk drives. One or more data storage drives of the NAS 100 may be easily removed and/or replaced. An additional hard disk drive may be connected to the NAS 100 by using a suitable cable and/or connector. As such, the NAS 100 provides an easily scalable and flexible storage mechanism that accommodates for future data storage growth. In addition, the NAS 100 may provide data mirroring and data striping capabilities.

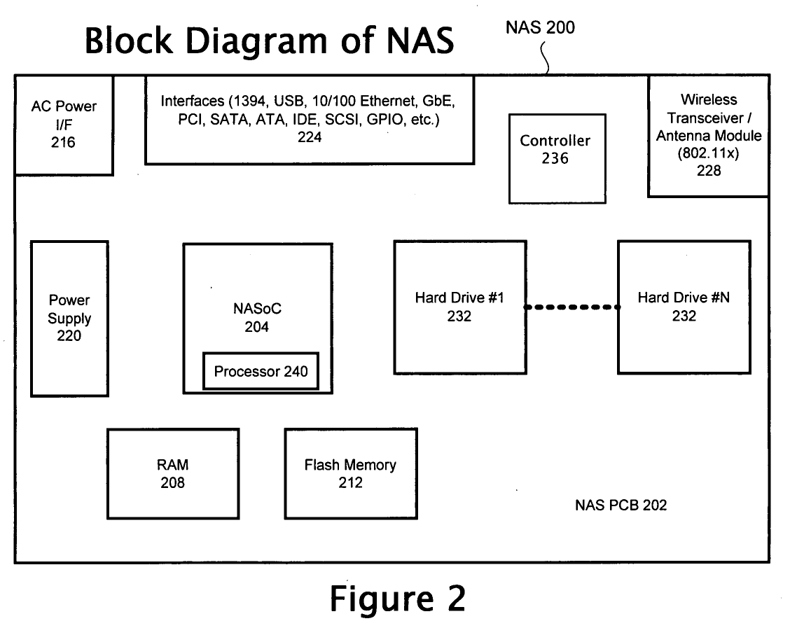

FIG. 2 is a block diagram of a data storage device or NAS 200 used to implement shared access to one or more FAT partitions of a FAT file system of a computing device, in accordance with an embodiment of the invention. The NAS 200 may comprise a printed circuit board (NAS PCB) 202 containing one or more components. The one or more components may be electrically connected by way of the printed circuit board (PCB) 202. The one or more components may comprise a NAS chip (NASoC) 204, a random access memory 208, a flash memory 212, an AC power interface 216, a power supply 220, a block of interfaces 224, a wireless transceiver/antenna module 228, one or more hard disk drives 232, and a controller 236. The interface block 224 may comprise one or more of the following interfaces: IEEE 1394, USB, 10/100 Ethernet, gigabit Ethernet, PCI, SATA, ATA, IDE, SCSI, GPIO, etc. The wireless transceiver/antenna module 228 may comprise an attachable module or mini-PCI card that may be optionally connected or attached to the NAS' printed circuit board 202. The one or more hard disk drives 232 may comprise any number of hard drives depending on the design of the NAS 200. The printed circuit board 202 may be configured to accommodate an appropriate number of hard disk drives. The number of hard drives utilized may depend on the type of mirroring or data striping (i.e., RAID) provided by the NAS 200. Aspects of the invention provide a means to allocate one or more portions of one or more hard disk drives into a data pool. For example, portions of one drive may be concatenated with portions from another drive in order to create a data pool. Further aspects of the invention provide a method of expanding storage capacity by adding additional hard disk drives to the NAS. Additional aspects of the present invention include the implementation of data striping and/or data mirroring (i.e., implementation of various RAID level functionality) of one or more data pools using one or more drives of differing sizes and speeds. In one embodiment, the controller 236 provides control for any one of several devices (such as hard disk drives) connected to the NASoC 204. The NASoC 204 may comprise an integrated circuit chip incorporating a processor or central processing unit (CPU) 240. The processor 240 may be used to execute software that configures, associates, or maps one or more shares to one or more FAT partitions. The NASoC 204 may comprise a digital integrated circuit chip capable of completely performing all NAS 200 related functions and operations used for providing shared access control of one or more FAT partitions of a FAT file system.

In one embodiment, the processor 240 within the NASoC (204 or 300) executes software or firmware (e.g., NAS software) residing within the RAM 208 or flash memory 212 when the NAS is booted up or powered up. In one embodiment, execution of the software or firmware generates one or more user interfaces allowing a user to configure one or more data pools that are created from portions of one or more hard disk drives. Additionally, the one or more user interfaces may allow a user to input a user name and/or password. The username and/or password may be used to determine the user's accessibility and level of accessibility to a particular share, for example.

In a representative embodiment, executing the NAS software or control access software provides share level access control to one or more FAT file systems. Each of the one or more FAT file systems does not provide inherent access control support. The various aspects of the invention provide a “foreign” share specific variable set used for defining the users or members capable of accessing a foreign share. This foreign share specific variable set is defined using one or more NVRAM variables. The one or more NVRAM variables may also provide a default permission level for the one or more users. The one or more NVRAM variables may be used to store one or more user passwords for authenticating one or more users who desire access to one or more foreign shares (or FAT partitions).

Access control may be implemented in one of the two ways. A first method may utilize a per share password, in which users with a valid share password may access the corresponding share. A second method may utilize a traditional approach that uses an individual's username and password. Each user may be granted various levels of access to a share: no access, limited access (e.g., read only), or full access.

A user or administrator may easily set up a share-specific password using an NVRAM variable. The password may comprise a value in a name-value pair, for example. The name in a name-value pair may be provided by the name of the NVRAM variable. In a representative embodiment, a user operating a CIFS client may be prompted for a password when he attempts access to a foreign share (i.e., a FAT partition). The password may be associated with one or more levels of access to the FAT partition. For example, the one or more levels of access may comprise the following: 1) no access, 2) read only access, or 3) full access. When full access is granted, the level of access may comprise reading or writing of data to the associated FAT partition.

An administrator may set up a password using a web browser that employs a configuration interface, for example. The administrator may also change or remove passwords for shares through the web configuration interface. In a representative embodiment, when a user sets or changes a password, the user may type it into an HTML input box. After confirming his password the administrator may click an “Apply” button such that the exemplary web page generates a HTTP “put” operation that transmits the new password as a field. The identity of the share associated with the password is also transmitted. Thereafter, a web server code may be executed within the NAS to facilitate receiving a “post” operation. The “post” operation triggers a hook embedded in the page being posted to set the share password as was specified by the administrator. The share password may be stored as a share-specific variable or NVRAM variable. In a representative embodiment, a share-specific variable or NVRAM variable is used to encode the password information. The password may be encoded in a format that facilitates creating a Unix-style password file entry. In a representative embodiment, the NVRAM variable is named cifs_protection_password_stuff. When the NAS boots, the NAS may verify its share-level access control configuration. The NAS may create a Unix password file and a Samba password file by reading the values associated with each cifs_protection_password_stuff variable for each share. (Samba is a protocol that is a variant of SMB (Server Message Block protocol)). Any share without such a cifs_protection_password_stuff variable may be considered unprotected and may not be included in the generation or creation of password files. In a representative embodiment, each share with such a cifs_protection_password_stuff variable may incorporate the name of the share as its username. The name of the share may be incorporated into the variable name, for example. The password information may be incorporated as a value for the variable, for example. Samba may be adapted for using one or more files that which contains this password information. The Samba configuration file may be created or re-created whenever Samba is started up or restarted. The Samba configuration file may be created or re-created when a major configuration change occurs. When the system is in share-level access control mode, Samba looks up the cifs_protection_password_stuff variable for each share. Shares which lack this cifs_protection_password_stuff variable may be configured using default permissions, but shares that have this variable are configured to allow access to a user having the same username as the name of the share. Since the password files are configured with a username entry that is identical to the share name, use of Samba will be able to identify the password information. When the NAS (or web server) receives a command to change the password associated with a share, it configures or sets the cifs_protection_password_stuff share-specific variable or NVRAM variable for that share. When the NAS receives a command to remove a password on a share, it unsets or removes the value associated with that share-specific variable or NVRAM variable. In a representative embodiment, a signal is sent to an “rc” program, which acts as a “master thread”, thereby causing the regeneration of the password related files and associated Samba configuration files. In one representative embodiment, the “SIGHUP” Linux signal is transmitted to all the running Samba processes, facilitating a re-read of one or more configuration files. In a representative embodiment, the password modification process is performed within a few seconds, such that any and all accesses to the associated share will operate using the new password.

Various aspects of the invention provide retention of values stored in a non-volatile memory (e.g., NVRAM) of a NAS when power supplied to the NAS is interrupted. For example, one or more passwords that are stored in the NAS may be unaffected when a power outage occurs or when power cycling of the NAS occurs, for example. Other aspects of the invention provide retention of values stored in the NVRAM of the NAS when one or more data storage drives (i.e., hard disk drives) are removed and/or replaced from the NAS. Use of the non-volatile random access memory (NVRAM) facilitates the retention of one or more critical values in the event of such occurrences.

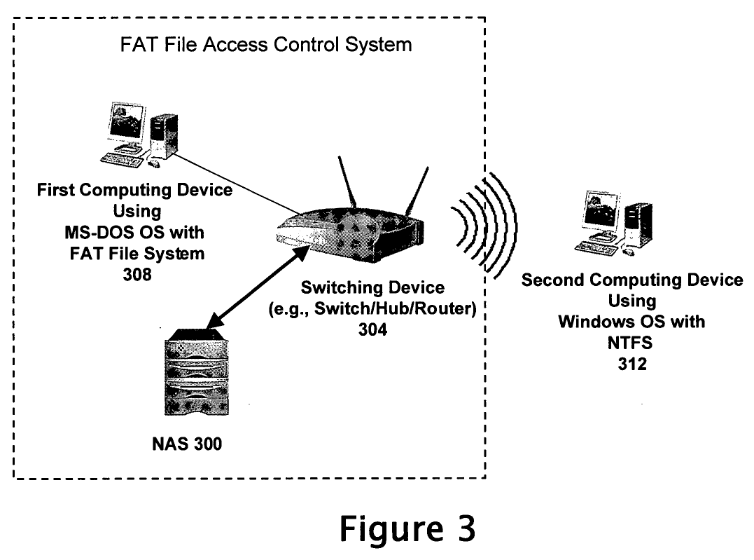

FIG. 3 illustrates a block diagram of a typical FAT file access control system incorporating the use of a data storage device or NAS 300 that is used to provide access to a FAT file system, in accordance with an embodiment of the invention. The FAT file access control system comprises a network attached storage device (NAS) 300, a switching device 304 (such as a switch, hub, or router), and a first computing device 308 that uses a legacy operating system (such as MS-DOS) incorporating a FAT file system. As shown, the NAS 300 is communicatively coupled to the first computing device 308 by way of the switching device 304. Although not part of the invention, FIG. 3 illustrates a second computing device 312 that uses a Windows operating system incorporating an NTFS file system. Although not shown in FIG. 3, a data storage device such as a NAS may typically communicate with any number of computing devices, each of which may utilize a FAT file system. In a representative embodiment, a user of the NAS 300 may access one or more FAT partitions of the first computing device 308 by way of a control access software that is executed by the NAS, as was previously described. The first and second computing devices may comprise a personal computer (PC) or PDA, for example.

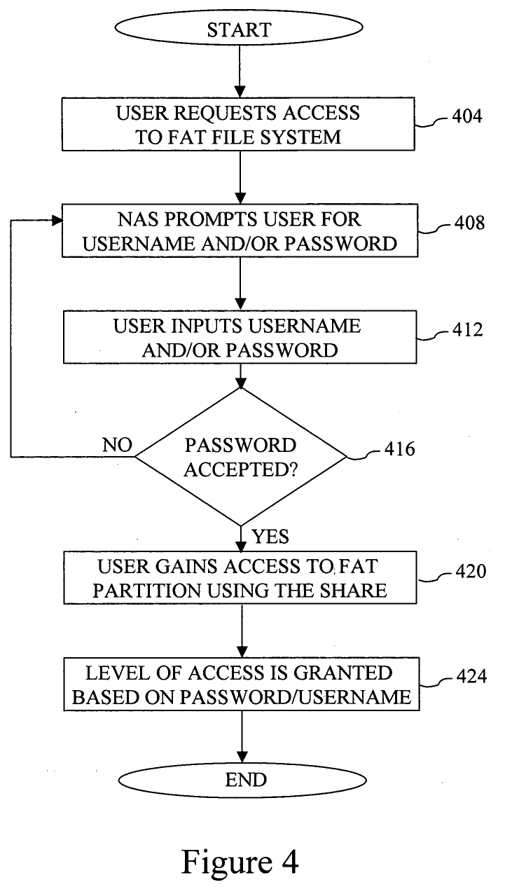

FIG. 4 is an operational flow diagram illustrating a method for accessing a FAT partition of a FAT file system in a computing or data processing device, in accordance with an embodiment of the invention. At step 404, a user requests access to data stored in the FAT partition of the FAT file system of the computing device. The computing device may utilize a legacy operating system such as MS-DOS, which organizes data using file allocation tables (FAT), for example. The user may request access by using a computing device communicatively coupled to a data storage device (e.g., NAS). As previously discussed, the NAS, of course, executes a control access software to facilitate access to a FAT partition of a FAT file system in one or more computing devices that are communicatively coupled to the NAS. The user may make the request for access to a data file stored in a FAT partition of a FAT file system by way of a user interface. The user interface may comprise a web browser such as Microsoft Internet Explorer, for example. Next, at step 408, the NAS may prompt the user for a username and/or password. The password may authenticate the user before access to a particular FAT partition is granted. In a representative embodiment, both a username and/or password may be used for authenticating the user. Thereafter, at step 412, the user inputs the username and/or password into the user interface. Next, at step 416, the NAS determines whether the password is recognized or accepted as a valid password. If the password is accepted as valid, the process continues at step 420. Otherwise, the process reverts back to step 408, in which, the NAS further prompts the user for a valid username and/or password. The share may be identified by way of one or more variables (e.g., or NVRAM variables, as previously described) used by the control access software of the NAS. The one or more variables may be set equal to one or more values. The one or more values may be stored in a memory, such as a non-volatile memory (e.g., NVRAM) of the NAS. The set of values represented by the one or more variables may be used to associate a particular FAT partition to a share. Further, the set of values may be used to identify one or more acceptable username(s) and/or password(s) that correspond to one or more users who are permitted access to the FAT partition. At step 420, the user may gain access to the FAT partition if the username and/or password correspond to the set of values that identify the requested FAT partition or share. Additionally, at step 424, the username and/or password may be used to identify the level of access granted to the user. For example, a user may be permitted either read access or read/write access, based on permission levels that are determined from the username and/or password.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of accessing a FAT partition comprising:
associating a shared directory to said FAT partition, said shared directory identified by using one or more variables;
configuring a password to authenticate a user requesting access to said FAT partition; and
providing a level of access to said FAT partition based on said password.

2. The method of claim 1 wherein said one or more variables is assigned one or more values, wherein said one or more values are stored in a non-volatile memory.

3. The method of claim 2 wherein said non-volatile memory is located within a data storage device.

4. The method of claim 3 wherein said FAT partition is located in a computing device, said computing device communicatively coupled to said data storage device.

5. The method of claim 3 wherein said configuring of said password is performed using said one or more variables whose values are stored in said non-volatile memory of said data storage device.

6. The method of claim 3 wherein said values stored in said non-volatile memory are unaffected by interruption of power provided to said data storage device.

7. The method of claim 3 wherein said values stored in said non-volatile memory are unaffected by removal and/or replacement of one or more data storage drives of said data storage device.

8. The method of claim 1 wherein said accessing is facilitated by way of using one or more of the following protocols: NFS (i.e., Network File System), CIFS (i.e., Common Internet File System), FTP (i.e., File Transfer Protocol), and HTTP (i.e., Hypertext Transfer Protocol).

9. The method of claim 1 wherein said level of access comprises read only access.

10. The method of claim 1 wherein said level of access comprises read and write access.

11. The method of claim 1 wherein said level of access comprises no access.

12. The method of claim 1 wherein said password is configured using a user interface.

13. A system for providing access to files stored in a FAT partition comprising:
a memory;
a software resident in said memory; and
a processor used for executing said software, wherein executing said software generates a share corresponding to said FAT partition.

14. The system of claim 13 wherein said executing said software generates a user interface such that a password may be input, said password used for authenticating a user requesting access to said files stored in said FAT partition.

15. The system of claim 14 wherein said password is used to provide a level of access to said files stored in said FAT partition.

16. The system of claim 15 wherein said level of access comprises read only access.

17. The system of claim 15 wherein said level of access comprises read and write access.

18. The system of claim 15 wherein said level of access comprises no access.

19. The system of claim 13 wherein said access to files is facilitated using one or more of the following protocols: NFS (i.e., Network File System), CIFS (i.e., Common Internet File System), FTP (i.e., File Transfer Protocol), and HTTP (i.e., Hypertext Transfer Protocol).
